(19) United States
(12) Patent Application Publication
(10) Pub. No.: US 2016/0030880 A1
(43) Pub. Date: Feb. 4, 2016

(54) CO2 CAPTURE WITH AMINES AND ACIDIC MATERIALS

(71) Applicant: WILLIAM MARSH RICE UNIVERSITY, Houston, TX (US)

(72) Inventors: Michael S. WONG, Houston, TX (US); Jerimiah FORSYTHE, Houston, TX (US); Mayank GUPTA, Houston, TX (US); Colin SHAW, Houston, TX (US); George HIRASAKI, Houston, TX (US); Kenneth R. COX, Houston, TX (US)

(21) Appl. No.: 14/814,119

(22) Filed: Jul. 30, 2015

Related U.S. Application Data
(60) Provisional application No. 62/031,050, filed on Jul. 30, 2014.

(51) Int. Cl. B01D 53/14

(52) U.S. Cl. CPC B01D 53/1425; B01D 53/1475; B01D 53/1493; B01D 2252/204

(57) ABSTRACT

An improved method of CO₂ capture is described. Typically, CO₂ is absorbed by an aqueous solution of amines at a first temperature to form a CO₂-amine reaction product, and desorbed at a second higher temperature. The improvement described herein adds a catalyst to the CO₂-amine reaction product in an amount such that the CO₂ desorption occurs at a lower temperature than the second higher temperature.

### PRIOR RELATED APPLICATIONS

This application claims priority to U.S. Provisional Application Ser. No. 62/031,050, filed Jul. 30, 2014, which is expressly incorporated by reference herein in its entirety for all purposes.

### FEDERALLY SPONSORED RESEARCH STATEMENT

This invention was made with government support under DE0007531 awarded by the DOE. The government has certain rights in the invention.

### FIELD OF THE DISCLOSURE

The present invention describes the use of acidic materials to reduce the energy needed to regenerate aqueous amine solutions used to capture CO₂ gas.

### BACKGROUND OF THE DISCLOSURE

There is growing concern over CO₂ emissions and its role in global warming. CO₂ emission is a serious threat to the environment and our health. Therefore, suppressing CO₂ emissions is more than ever of paramount importance.

Coal plants and fuel-powered electric power plants produce a large amount of CO₂. According to the Intergovernmental Panel on Climate Change, power plants produce approximately 78% of stationary source emissions of CO₂. The ever-growing combustion processes of fossil fuels have increased the concentration of CO₂ in the atmosphere, which is causing global warming and drastic climate change. Roughly 80% of greenhouse gas emissions consist of carbon dioxide. To stabilize the global warming, by 2050, CO₂ emissions from all energy related technologies should be reduced to half of the level in 2007 according to the International Energy Agency (IEA).

One of the most effective and promising ways to mitigate CO₂ emissions to the environment is post-combustion CO₂ capture. Approximately 10% reduction in CO₂ emissions can be achieved by using carbon capture and storage (CCS) in power plants. At present, CCS is applied via three routes—pre-combustion, oxy-fuel combustion, and post-combustion. Post-combustion is considered to be better than the other alternatives because it is easier to retrofit in existing power plants. Most of the post-combustion technologies are at the research & development stage, however, amine-based absorption technology has been commercially demonstrated and thus is the leading technology in the field. Among various CO₂ capture techniques, absorption is an attractive option because of its potential for simple operation, low corrosiveness and low cost.

Chemical absorption of CO₂ by an aqueous amine is one of the most mature and effective techniques for CO₂ capture. However, commercial applications have been restricted due to the high costs associated with this technology. More than 50% of the costs incur from regeneration of the solvent because of the heat necessary for the regeneration process. Absorption of CO₂ using an aqueous amine solution is carried out at 40-60° C. and then the solution is regenerated by heating it to 100-150° C. in conventional systems. Therefore, it is necessary to develop absorbents that will have high absorption rate, high absorption capacity, and low heat of reaction during regeneration.

The absorption-based CO₂ capture plant has an absorption column and a regeneration/stripping column as shown in FIG. 1. An amine scrubbing process is based on the chemical absorption of weak acid i.e. CO₂ and weak base amine, such as monoethanolamine (MEA) (R is HO(CH₂)₂⁻). CO₂ reacts reversibly with an amine solution and forms a carbamate anion as shown in the following reactions:

RNH₂+CO₂⇄RNHCOO⁻+H⁺

Absorption of CO₂ with amines is an exothermic reaction and regeneration is an endothermic reaction. The absorption is carried out at low temperatures (40-60° C.) and regeneration at high temperatures (100-150° C.). Heat is also required to regenerate the solvent and, therefore, significantly adds to the cost of the process. Additionally, problems such as degradation and evaporation of amines are unavoidable at such high temperatures. For instance, solvent degradation costs around 10% of total cost of CO₂ capture. Also, the compounds formed during degradation are harmful to the environment and their release into the atmosphere is easy because they are volatile. A coal plant would need 20-30% of its energy production to sustain an efficient CO₂ sequestration process under conventional regeneration conditions. Therefore, to minimize the energy requirements, it is preferred to carry out the regeneration at lower temperatures.

Many researchers have used mixtures of primary or secondary amines and tertiary amine to desorb CO₂ more effectively to reduce regeneration energy cost. Mixtures are better than individual amines because primary or secondary amines exhibit high rates of absorption and tertiary amines exhibits high heats of reaction (requires less heat in the stripper section). Recently, electrochemical regeneration of amine has been used in stripping sections to reduce regeneration temperatures, improved utilization of the amine per cycle, and increase CO₂ desorption pressure.

Several patents describe amine-based methods for CO₂ capture and regeneration of amine solutions; however most of these patents use a regeneration temperature of 100° C. or more. To improve energy efficiency, U.S. Pat. No. 7,485,274 discloses an apparatus and a method for CO₂ recovery using amine-based absorption and desorption units where regeneration temperature was about 110° C. A combination of basic amine(s) in the presence of a stronger non-nucleophilic base as the sorbent has also been used to reduce the regeneration temperature to 70° C.

Publication US20140178278 discloses a method for separating CO₂ from a gas mixture using one or more sterically hindered amines as the sorbent. The authors used 2-amino-2-methyl-1-propanol (AMP) to precipitate the CO₂ loaded amine solution. The patent claims that the sorbed CO₂ is desorbed from the rich amine stream in at least one regeneration zone at a temperature of 95° C. or less.

Publication WO2012034921 describes a process for the CO₂ capture from gas mixtures and for the CO₂ removal from gaseous wastes of industrial processes or combustion gases, which is carried out by bringing into contact the gas mixtures with an absorbent solution of amines in anhydrous alcohols. This process comprises CO₂ absorption at room temperature and 1 atm, and amine regeneration at temperatures lower than the boiling temperature of the solution and at 1 atm. It was claimed that the process required less energy compared to the conventional counterparts because of low regeneration temperatures (65-80° C.) and 1 atm. It was found that thermal decomposition of the amine was significantly reduced because of the low regeneration temperature. A hindered amine (AMP) was used with alcohols so that it reacts with CO₂ to form alkyl carbonate and unstable amine carbamate instead of stable bicarbonate. Due to lower thermal stability of CO₂ containing species, the process does not require high regeneration temperature.

Publication WO2013000953 describes improved absorbents that spontaneously form two separated phases after absorbing CO₂, and a method for capturing CO₂ from gas mixtures. Mixtures of aqueous solution of amines-primary or secondary, and a tertiary amine were used. It was reported that before absorption of CO₂, the absorbents may be a homogeneous solution or two immiscible or partly miscible aqueous phases. After CO₂ absorption, the absorbent spontaneously separated into two immiscible phases, one comprising absorbed CO₂ (CO₂-rich phase) and other with no CO₂ (CO₂-lean phase). The phases differ in density and therefore the separation was quick and efficient. The CO₂ lean phase was returned to the absorber and CO₂-rich phase was sent to the regeneration column. Therefore, less absorbent had to be heated in the regeneration column (temperature 80-90° C.).

Publication CA2780194 discloses the use of an absorbent mixture to remove CO₂. One such mixture was 50 wt. % H₂O, 37 wt. % piperazine (secondary diamine) and 13 wt. % AMP (a sterically hindered amine), which gave a significantly lower residual CO₂ load under the same regeneration conditions (120° C.) than a mixture of 50 wt. % H₂O and 50 wt. % piperazine.

Publication WO2012021728 describes the use of geothermal energy to regenerate the amine solvent used for CO₂ capture from coal-fired power plants or other gas sources. It also discloses a multi-stage stripper configuration to regenerate amine solvents over a range of temperatures. A method involving thermal compression of CO₂ from amine solvent regeneration at elevated pressure using heat rather than electricity is also disclosed.

Although all of these patents provide some improvement to the process, none has yet achieved a cost effectiveness warranting implementation in a large plant. Thus, what is needed in the art are better methods of CO₂ capture that avoid some of the above disadvantages and provide one or more advantages over the prior art.

### SUMMARY OF THE DISCLOSURE

We have developed an amine-based process for CO₂ capture that uses a catalyst material to enhance the regeneration of spent amine solutions. Our process involves the absorption of CO₂ at 40° C. and it's desorption at lower temperatures than conventional methods.

The catalyst material is an acidic material and can be a metal oxide or combinations thereof, including zeolites, and/or proton-exchange (or acid) resins.

Any metal oxide can be used, including metals from rows 3-5 in the Periodic Table, such as aluminum, titanium, vanadium, molybdenum, tungsten, iron, manganese, cobalt, chromium, silver. Exemplary metal oxides include vanadium oxide (V₂O₅), molybdenum trioxide (MoO₃), tungsten oxide (WO₃), aluminum oxide (Al₂O₃), and the like. Additionally, zeolites, which are aluminosilicate materials that act as ion exchangers, can also be utilized as catalyst.

Additionally, proton-exchange resins can also be used as a catalyst. Proton-exchange resins have shown promise in enhancing regeneration of spent amine solutions. Acidic ion exchange resins from Rohm & Hass, Mitsubishi Chemicals, Aldex and Dow Chemical are just a few of the commercially available polymeric resins. However, in-house resins can also be utilized.

Low temperature (40-90° C. or 50-84° C. or about 65-75° C.) regeneration was achieved by adding a metal oxide or resin to an amine solution during the regeneration/desorption step. More specifically, our results showed that vanadium oxide (V₂O₅), molybdenum trioxide (MoO₃), and tungsten oxide (WO₃) caused CO₂ to desorb at lower temperatures compared to the base case of a CO₂-loaded MEA solution only. An acidic material is hypothesized to catalyze the carbamate break-down reaction (which is the reverse reaction of the CO₂+amine reaction). Amberlyst resin resulted in a higher amount of CO₂ desorption, too.

The present invention may be used in regeneration of aqueous amines and its mixtures in a CO₂ capture plant. Our process enables the regeneration column to operate at lower temperatures, which can potentially result in significant cost savings because of less energy consumption. In addition to this, low operating temperature would significantly reduce the degradation and evaporation of amine solutions.

Further, the catalysts may still be viable when used at normal regeneration temperatures, resulting in a higher desorption of CO₂ than if the catalyst was not used.

Our process can further reduce the cost of existing amine-based CO₂ capture technology by preventing degradation and evaporation of amine solutions.

The inventive combination can be applied to any amine-based CO₂ absorption system known in the art, including reagents and engineering designs described in US20100029466, US20100062926, U.S. Pat. No. 7,892,509, US20110088553, U.S. Pat. No. 7,918,926, U.S. Pat. No. 8,409,339, U.S. Pat. No. 8,529,678, U.S. Pat. No. 8,535,427, U.S. Pat. No. 8,764,884, US20070283813, US20110113965, US20110113966, US20110120315, US20130323147, US20120063980, US20120279393, WO2012021728, U.S. Pat. No. 8,105,420, U.S. Pat. No. 7,485,274, US20140178278, WO2012034921 or US20140178279, each incorporated by reference herein in its entirety for all purposes.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention, such as instructions for use, buffers, and the like.

The following abbreviations are used herein:

| ABBREVIATION | TERM |
|---|---|
| MEA | Monoethanolamine |
| DAB | 1,4-diaminobutane |
| DAP | 1,3-diamino-2-propanol |
| DEEA | 2-diethylamino-ethanol |
| DiAP | 1,3-propanediamine |
| DIPAE | 2-diisopropylamino-ethanol |
| DMPDA | 2,2-dimethyl-1,3-propanediamine |
| HEP | 1-piperazineethanol |
| MAPA | N1-methyl-1,3-Propanediamine |
| N-TBDEA | N-tert-butyldiethanolamine |
| PZ | Piperazine |
| IEP | Isoelectric point |

### BRIEF DESCRIPTION OF THE DRAWINGS

FIG. 1. Schematic of an exemplary amine-based absorption capture system (*12.5-12.8% CO₂, 76-77% N₂, 6.2% H₂O, ˜4.4% O₂, 50 ppm CO, 420 ppm NOₓ, 420 ppm SO₂).

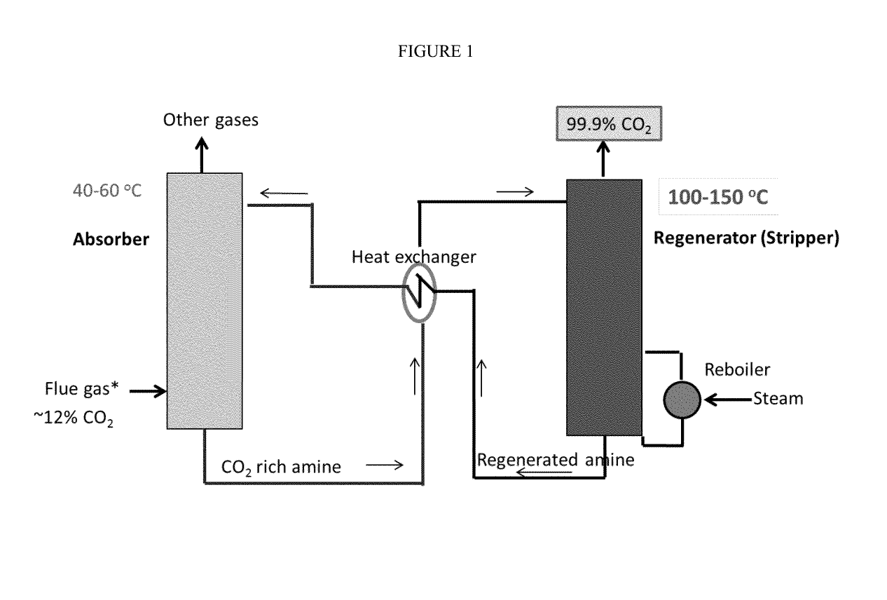

FIG. 2. Changes in solution color of 3 M MEA with 1.5 g of V₂O₅ over a 60-minute period.

FIG. 3. Desorption profile of CO₂ from 3 M MEA with 1.5 g of WOₓ/γ-Al₂O₃. A typical temperature ramp at 2.3° C./min is displayed on the right y-axis.

### DETAILED DESCRIPTION

The following experiments are exemplary only, and should not serve to unduly limit the claims, which are read to include all methods covered by the claims under the ordinary meanings of the words therein, plus any equivalents.

### Methods

The invention is an improved process for regenerating an aqueous amine solution or a mixture of amine solutions. To test the method, the catalyst was dried, the amine solution was loaded with CO₂, and then the desorption process was monitored using the following steps:

Catalyst Drying Step

The catalyst was dried in one of two ways. In the first method, hereinafter the “vacuum drying method”, the catalyst powder was dried under vacuum at 150° C. for at least 2 hours prior to desorption studies. Alternatively, a second method involved calcining the catalyst materials at 450° C. for 1 h under flowing helium/air before the desorption test. The results for materials dried under method 1 are in Tables 1 and 2A-B. The results for the catalyst dried under method 2 are in Tables 3 and 4.

The metal oxides (including zeolites) were dried using both methods. The resin was dried using the vacuum drying method. Either method can be used. However, applicants found slightly better results using the calcination drying method.

CO₂ Loading Step

For the vacuum dried catalysts, an aqueous solution of 18.3% (3M) monoethanolamine (MEA) was prepared using reagent grade MEA (Sigma-Aldrich) and DI water. An aqueous solution of 12.9% (1.5M) piperazine (PZ) was prepared using reagent grade PZ (Sigma-Aldrich) and DI water. CO₂ was loaded onto 15 mL of an aqueous solution of 3M MEA using a gas mixture containing 1.67% CO₂/N₂ (volume basis) for approximately 30 min. Following loading of CO₂, the flask was purged with N₂ for 10 minutes to flush the headspace and return the flask to a full N₂ atmosphere.

For the calcined catalyst, an aqueous solution of 18.3% (3M) monoethanolamine (MEA) was prepared using reagent grade MEA (Sigma-Aldrich) and DI water. CO₂ was loaded onto 15 mL of an aqueous solution of 3M MEA using a gas mixture containing 1.67% CO₂/N₂ (volume basis) for approximately 30 min. The temperature during absorption was 40° C. Following loading of CO₂, the flask was purged with N₂ for 10 min to flush the headspace and return the flask to a full N₂ atmosphere. The experiments were carried out in a 50 mL four-neck round bottom flask.

Desorption

For the vacuumed dried catalyst, 1.5 g of powder was introduced into the solution and allowed to equilibrate for 15 minutes at absorption temperatures. The desorption process was initiated by applying heat through a heating mantle controlled by a J-KEM model 210 temperature controller set to heat to 100° C. at 10° C. min⁻¹. Final temperature of the solution was 86±2° C.

For the calcined catalyst, 1.5 g of powder was introduced into the MEA solution and allowed to equilibrate for 15 minutes at 40° C. Thereafter, the reaction was allowed to progress for 60 min. The desorption process was initiated by applying heat through a heating mantle controlled by a J-KEM model 210 temperature controller. The heating rate was 2.3° C. min⁻¹. Final temperature of the solution was 89±6° C.

High gas flow rates (on the order of 1000 mL min⁻¹) were used to provide enough dilution to maintain the concentration of CO₂ entering the detector below the calibration limit of 20,000 ppm. Stopping the nitrogen flow caused the solution to achieve the desired 100° C. set-point temperature.

CO₂ evolution was monitored at 1 second intervals by an IR detector (Li-Cor Li-820 CO₂ analyzer) on the exit stream of gas after passing through a condenser operating at 4° C. for both vacuum dried catalyst and calcined catalyst to remove any residual moisture from the solution.

The results for the vacuum dried catalyst will be described first, followed by the catalyst that undergone the calcination drying.

Regeneration of MEA Using Vacuum Dried Catalyst

Regeneration of MEA and PZ using vacuum dried catalyst were studied. UV-Vis absorbance measurements were performed with 15 mL of CO₂ free, 3 M MEA and 1.5 M PZ. 1.5 g of previously vacuum dried catalyst was added to a 50 mL vial of CO₂ loaded amine solutions and the reactions were allowed to progress. CO₂ evolution was monitored at 1 second intervals by an IR detector (Li-Cor Li-820 CO₂ analyzer) on the exit stream of gas after passing through a condenser operating at 4° C. to remove any residual moisture from the solution.

Catalyst-free baseline: CO₂-loaded MEA solution without a catalyst was heated from room temperature to 86° C. and the CO₂ concentration of the off-gas from the solution-containing flask as a function of time (base case) to determine a base line for our experiments. We observed 31.6% of the CO₂ was released after 30 min (and ˜50% after 60 min), with peak release at 14 min (Table 1).

Metal Oxides: The abilities of various metal oxides, dried using the vacuum method, to increase CO₂ release were then tested, with the results shown in Table 1. As can be seen, WO₃ increased the release of CO₂ from MEA. WO₃ caused more CO₂ release than MEA only after 76° C. as shown in Table 1, the maximum CO₂ release peak was observed at 13 min compared to 14 min for MEA only. In the case of WO₃, 60% CO₂ was desorbed, higher than the CO₂ amount desorbed (49%) by MEA only. However, WO₃ dissolved partially in the MEA solution

Further results show that the pH of the CO₂-MEA solution did not change in the presence of the metal oxides, indicating that the enhanced CO₂ release was consistent with the hypothesis that a metal oxide of sufficient surface acidity catalyzes the degradation of CO₂ -MEA complex and subsequent release of CO₂.

TABLE 1
CO₂ desorption data from 3M MEA with 1.5
g of various vacuum dried metal oxides.

| | | | Time (min), | |
|---|---|---|---|---|
| | Cumulative % | Cumulative % | temperature | |
| | CO₂ released | CO₂ released | (° C.) of max | |
| | by 30 min | by 60 min | CO₂ release | |
| MOₓ | at 86° C. | at 86° C. | peak | IEP^{a} |
| No Material | 31.6 | 49.2 | 14, 84 | N/A |
| (MEA Only) | | | | |
| WO₃ | 34.7 | 60.0 | 13, 73 | 0.2-0.5 |
| V₂O₅ | 45.8 | 69.0 | 10.5, 76 | 1-2 |
| MoO₃ | 65.8 | 76.2 | 10, 82 | 2.5 |
| MnO₂ | 29.8 | 46.8 | 15, 84 | 4-5 |
| Cr₂O₃ | 29.7 | 46.8 | 15, 84 | 7 |
| α-Al₂O₃ | 29.4 | 47.0 | 14, 84 | 8-9 |
| MgO | 13.7 | 22.3 | 13, 80 | 12-13 |

^{a}Kosmulski, M. “Chemical Properties of Material Surfaces”, Marcel Dekker, 2001.

MoO₃ started desorbing CO₂ at 40° C. during the initial 15-minute equilibrium step. MoO₃ also caused CO₂ to desorb at lower temperatures than CO₂-loaded MEA solution (without metal oxide). However, MoO₃ dissolved in the MEA solution. MoO₃ helped release the highest amount of CO₂ in the 60 min period, which was 27% more than the MEA solution without an oxide (Table 1).

V₂O₅ started desorbing CO₂ at 40° C. during the initial 15-minute equilibrium step. Like WO₃ and MoO₃, V₂O₅ also caused CO₂ to desorb at lower temperatures than CO₂-loaded MEA solution (without metal oxide). V₂O₅ dissolved in the MEA solution, attributed to metal-MEA complex formation. The solution also changed color. The solution turned from yellow-orange (0 min) to green (˜25 min), suggesting reduction of the vanadium cation. The results showed that, while dissolution was observed, improved CO₂ release (in terms of larger quantity and/or lower temperature) was also observed.

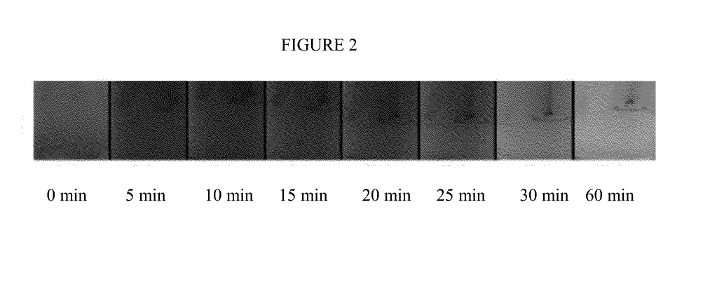

FIG. 2 shows the observed color changes (as shades of grey) in solution as the reaction progresses from initial 0 minutes to conclusion at 30 minutes, followed by a final observation at 60 minutes. There have been previous reports of complexes between reduced vanadium and ethanolamine in aqueous solutions that results in the reduction of vanadium. Thus, the color change from yellow-orange (FIG. 2, dark grey) to green (FIG. 2, light grey) is likely due to the reduction of vanadium in the presence of ethanolamine (V⁵⁺ to V³⁺).

One potential material issue about V₂O₅ and MoO₃ is that they dissolved completely during the process, which is undesirable for our current process. Whereas WO₃ dissolved partially. However, operating at lower temperatures or using different amine solutions in the capturing process can overcome this.

Resins: The abilities of a proton-exchange resin dried using the vacuum method, to increase CO₂ release and reduce the temperature in the regeneration of the amine solution was also tested. Characteristics of the chosen resin are in Table 2A and results from the desorption experiments are in Table 2B.

TABLE 2A
Characteristics of Vacuum Dried Proton-Exchange Resin

| | Isoelectric | Surface | Surface |
|---|---|---|---|
| | Point | Area | Density |
| Material | (IEP) | (m²/g) | (atoms/nm²) |
| Proton-exchange resin | — | 42.3 | — |
| (Amberlyst 15 (H)) | | | |
| (concentration of acid | | | |
| sites: 4.7 ≧ eq/kg) | | | |

Addition of a proton-exchange resin to MEA during CO₂ desorption step enhances its release/desorption only marginally (38.9% to 43.9%). CO₂ release is almost the same (˜14%) as the baseline case (MEA without any material) during ramp stage. However, the proton-exchange resin caused slightly more CO₂ release/desorption (43.9% compared to 38% of the baseline case) during soak time. Overall, it released 5% more CO₂ than the baseline case. The temperature during desorption is higher than the baseline example probably due to exothermic side reactions in presence of the resin. However, the amount of CO₂ released is greater.

TABLE 2B
CO₂ desorption data from 3M MEA with 1.5 g of Vacuum Dried Proton-Exchange Resin

| | Surface | % CO₂ | Temp. | % CO₂ | | % CO₂ |
|---|---|---|---|---|---|---|
| | Acidity | released | Range | released | Average | released |
| Material | Characteristic | (Ramp) | (° C.) | (Soak) | Temp. (° C.) | after 60 min |
| MEA only | — | 13.6 | 41-82 | 25.3 | 84 | 38.9 |
| Proton-exchange | Strongly acidic | 14.1 | 44-92 | 29.8 | 94 | 43.9 |
| resin (Amberlyst 15 | | | | | | |
| (H)) | | | | | | |

Regeneration of MEA Using Calcined Catalyst

The catalysts were also tested after having been dried using a calcination method instead of vacuum drying. For the calcined experiments, all the materials were purchased from different vendors except MOx/γ-Al₂O₃, which were synthesized as followed:.

First, ammonium salt of the desired metal is dissolved in DI water and 10% NH₄OH. Thereafter, γ-Al₂O₃ powder is added to the aqueous solution of metal salt, which is left stirring for 20 minutes at room temperature. The material is then placed in the oven to dry for 21 h at 105° C. Activation of the catalyst and removal of moisture from the voids (calcination) is carried in a furnace at 450° C. for 8 h in He/air.

1.5 g of calcined powder was introduced into the MEA solution and allowed to equilibrate for 15 minutes at 40° C. Thereafter, the reaction was allowed to progress for 60 min. The desorption process was initiated by applying heat through a heating mantle controlled by a J-KEM model 210 temperature controller. The heating rate was 2.3° C. min⁻¹. Final temperature of the solution was 89±6° C. CO₂ evolution was monitored at 1 second intervals by an IR detector (Li-Cor Li-820 CO₂ analyzer) on the exit stream of gas after passing through a condenser operating at around 4° C. to remove any residual moisture from the solution.

Characteristics of the chosen catalysts are in Table 3 and the results of the desorption experiments are shown in Table 4.

TABLE 3
Solid Materials Tested

| | Isoelectric | Surface | Surface |
|---|---|---|---|
| | Point | Area | Density |
| Material | (IEP) | (m²/g) | (atoms/nm²) |
| H-Zeolite Y | 5.0 | 633.4 | — |
| (composition:SiO₂/ | | | |
| Al₂O₃ = 5.1:1) | | | |
| WO₃ | 0.3 | 1.2 | — |
| WOₓ (54.9 wt %)/γ-Al₂O₃ | — | 49.3 | 43.9 |
| V₂O₅ | 1-2 | 4.5 | — |
| VOₓ (3.0 wt %)/γ-Al₂O₃ | — | 137.9 | 7.0 |
| MoO₃ | 2.5 | 0.9 | — |
| MoOₓ (14.3 wt %)/γ-Al₂O₃ | — | 80.0 | 24.3 |
| γ-Al₂O₃ | 7-8 | 144.4 | — |
| MgO | 12-13 | 115.8 | — |

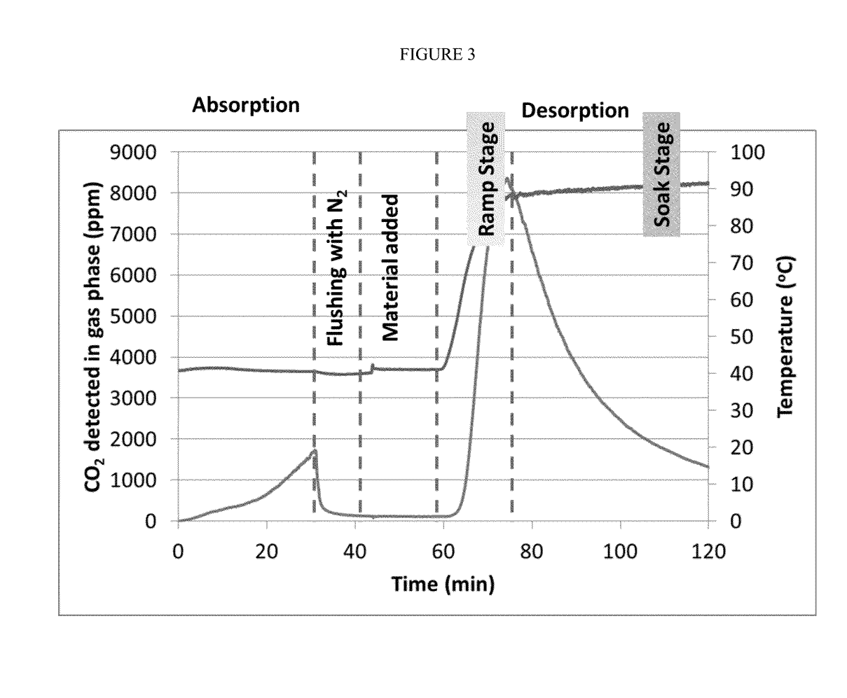

FIG. 3 shows an example of CO₂ absorption, desorption, and temperature profiles. These profiles were obtained, when the MEA solution was first loaded with CO₂ and then slowly heated from 40° C. (MEA) to maintain the temperature around 84° C. The same amount of heat was provided in all the cases to better compare the desorption rate of samples having a catalyst with the baseline sample having no catalyst. However, slightly different temperatures observed were probably due to different exothermic side reactions with various materials. As shown in FIG. 3, there are two separate regions—‘ramp’ and ‘soak’ stage. During the ramp stage, temperature increases to 89±6° C. in about 15 min. During the soak stage, the temperature remains nearly constant ranging from 84 to 95° C. depending upon the material. CO₂ released, is shown on y-axis and the area under the curve gives its amount. During absorption, there is some release of CO₂ as shown in FIG. 3; it was subtracted from the total CO₂ fed to the reactor to get the total CO₂ absorbed by MEA.

Table 4 shows different materials, CO₂ released/desorbed and the temperature range during the ramp stage. CO₂ released shown in the table is calculated as follows:

$$\% {CO}_{2} released / desorbed = \frac{100 \times {CO}_{2} released from MEA}{Total {CO}_{2} absorbed by MEA}$$

TABLE 4
CO₂ desorption data from 3M MEA with 1.5 g of Calcined Materials

| | Surface | % CO₂ | Temp. | % CO₂ | | % CO₂ |
|---|---|---|---|---|---|---|
| | Acidity | released | Range | released | Average | released |
| Material | Characteristic | (Ramp) | (° C.) | (Soak) | Temp.(° C.) | after 60 min |
| None | — | 13.6 | 41-82 | 25.3 | 84 | 38.9 |
| H-Zeolite Y | Acidic | 11.2 | 42-90 | 29.7 | 87 | 40.9 |
| (SiO₂/Al₂O₃ = 5.1:1) | | | | | | |
| WO₃ | Strongly acidic | 21.3 | 42-83 | 32.7 | 85 | 54.0 |
| WOₓ (54.9 wt % WO₃)/ | Acidic | 12.9 | 41-87 | 34.6 | 90 | 47.5 |
| γ-Al₂O₃ | | | | | | |
| MoO₃ | Strongly acidic | 46.3 | 41-82 | 20.3 | 84 | 66.5 |
| MoOₓ (14.3 wt % | Weakly Acidic | 24.0 | 41-85 | 28.3 | 84 | 52.2 |
| MoO₃)/γ-Al₂O₃ | | | | | | |
| V₂O₅ | Strongly acidic | 36.0 | 40-83 | 23.3 | 84 | 59.2 |
| VOₓ (3.0 wt % V₂O₅)/γ- | Weakly acidic | 14.8 | 43-94 | 48.7 | 91 | 63.6 |
| Al₂O₃ | | | | | | |
| γ-Al₂O₃ | Weakly acidic | 13.7 | 42-85 | 25.7 | 89 | 39.4 |
| MgO | Basic | 3.6 | 43-94 | 21.2 | 95 | 24.8 |

Acidic oxides increased the release of CO₂ from MEA, most likely because metal oxide of sufficient surface acidity catalyzes the degradation of CO₂-MEA complex and subsequent release of CO₂.

H-Zeolite Y did not have any effect on the total CO₂ release/desorption. CO₂ release was 11.2%, less than the baseline case during ramp stage. However, it increased CO₂ release/desorption (29.7%) during soak time, same as MEA with proton-exchange resin. Overall, it released 2% more CO₂ than the baseline case.

WO₃ enhanced CO₂ release/desorption from 38.9% to 54%. CO₂ release (21.3%) was significantly higher than the baseline case during ramp stage. CO₂ release/desorption increased to 32.7% during soak time. Overall, it released 15.1% more CO₂ than the baseline case.

As expected, WOₓ/γ-Al₂O₃ enhanced the CO₂ release/desorption from 38.9% to 47.5%. CO₂ release (12.9%) was less than the baseline case during ramp stage. WO₃/γ-Al₂O₃ increased the CO₂ release/desorption to 34.6% during soak time. Overall, it released approximately 8.6% more CO₂ than the baseline case, but still less than WO₃ only.

Addition of MoO₃ resulted in significant increase in total CO₂ release (66.5%). During ramp stage, it increased CO₂ release to 46.3%, a five-fold increase. However, it had less CO₂ release/desorption (20.3% compared to 25.3% of the baseline case) during soak time. Overall, it released 27.6% more CO₂ than the baseline case.

Addition of MoOₓ/γ-Al₂O₃resulted in significant increase in CO₂ release (52.2%), although less than MoO₃ only. During ramp stage, CO₂ release (24%) was around two times more than the baseline case. It also had more CO₂ release/desorption (28.3% compared to 25.3% of the baseline case) during soak time unlike MoO₃. Overall, it released 13.3% more CO₂ than the baseline case.

Addition of V₂O₅ increased the CO₂ release/desorption from 38.9% to 59.2%. CO₂ release (36%) was more than the baseline case during ramp stage. However, it had slightly less CO₂ release/desorption (23.3%) during soak time. Overall, it released approximately 20.3% more CO₂ than the baseline case.

Addition of VOₓ/γ-Al₂O₃ to MEA during CO₂ desorption step enhances its release/desorption significantly (from 38.9% to 63.6%). CO₂ release is almost the same (˜14.8%) as the baseline case during ramp stage. However, during soak time it increased CO₂ release/desorption to 48.7% from 25.3% of the baseline case. Overall, it released approximately 24.7% more CO₂ than the baseline case.

Both supported and unsupported metal oxides enhanced the CO₂ release/desorption. For supported metal oxides, this enhancement could be due to γ-Al₂O₃ because it is slightly acidic. To test this hypothesis, we conducted experiments with γ-Al₂O₃ only and found that it had the same CO₂ release as the baseline case for both during ramp and soak stages. It can also be inferred from the table that MgO has significantly lower CO₂ release than the baseline case because it is basic in nature and absorbs CO₂.

Thus, the results show that metal oxides and resins can improve the regeneration process. Even though the experiments were performed with the same temperature range as the baseline sample, the increase in CO₂ desorption at various times is observable. Though a difference was observed with different drying techniques, it is expected that any drying technique known or to be developed will still enable the catalyst to perform.

Dissolution of the materials was observed during the experiment. This phenomenon is likely due to the formation of a complex between MEA and metal oxide. The supported catalysts exhibited less dissolution, which shows that γ-Al₂O₃ helps reducing the dissolution of metal oxide. For example, the amount of W dissolved, which was 53% reduced to 24% when γ-Al₂O₃ was used as a support. Similarly, the dissolution reduced to 68% from 96% in the case of MoO3, and 79% from 88% in the case of V₂O₅. We did not observe the dissolution of γ-Al₂O₃. When the pH of the solution was decreased, the material precipitated back. This pH swing can be used to recover the material.

Mixtures of metal oxides besides zeolites may also work in the inventive methods, for either drying methods. In addition to metal oxides, metal non-oxide and metal materials are possible candidates for catalyzing the carbamate degradation reaction. The catalyst may be in powder form, pelletized form, or as a washcoat on an extended surface. Amine solutions or mixtures of amine solutions may be chosen for a particular solid material to minimize dissolution of the solid.

This process may be useful for other applications in which an acid gas (or a gas that can react with amine solutions) needs to be removed, such as H₂S.

The following references are incorporated by reference in their entirety for all purposes:

Bishnoi, S. & Rochelle, G. T., Absorption of carbon dioxide into aqueous piperazine: reaction kinetics, mass transfer and solubility. Chemical Engineering Science, 2000. 55(22): p. 5531-5543.

Choi, S. et al., Adsorbent Materials for Carbon Dioxide Capture from Large Anthropogenic Point Sources. Chemsuschem, 2009. 2(9): p. 796-854.

Gouedard, C. et al., Amine degradation in CO₂ capture. I. A review. International Journal of Greenhouse Gas Control, 2012. 10: p. 244-270.

Idem, R, et al., Pilot plant studies of the CO₂ capture performance of aqueous MEA and mixed MEA/MDEA solvents at the University of Regina CO₂ capture technology development plant and the Boundary Dam CO₂ capture demonstration. Industrial & Engineering Chemistry Research, 2006. 45(8): p. 2414-2420.

Leon, M. et al, A kinetic study of CO₂ desorption from basic materials: Correlation with adsorption properties. Chemical Engineering Journal, 2011. 175: p. 341-348.

Matsuzaki, Y. et al., Ab Initio Study of CO₂ Capture Mechanisms in Aqueous Monoethanolamine: Reaction Pathways for the Direct Interconversion of Carbamate and Bicarbonate. Journal of Physical Chemistry A, 2013. 117(38): p. 9274-9281.

Siskin, M. et al., CO₂ capture via amine-CO₂ product phase separation, USPTO, Editor. 2014, Exxonmobil Research And Engineering Company: USA.

Stern, M. C. et al., Post-combustion carbon dioxide capture using electrochemically mediated amine regeneration. Energy & Environmental Science, 2013. 6(8): p. 2505-2517.

Su, F. S. et al., Capture of CO₂ from flue gas via multiwalled carbon nanotubes. Science of the Total Environment, 2009. 407(8): p. 3017-3023.

Svendsen, H. F. & TROLLEBØ, A. A., An amine absorbent and a method for CO₂ capture. 2013, Google Patents.

Total, http://www.total.com/en/society-environment/environment/climate-and-carbon/capturing-and-storage-carbon-reduce-air-emissions.

US20100029466, Absorbent regeneration with compressed overhead stream to provide heat.

US20100062926 Absorbent regeneration with flashed lean solution and heat integration

US20110088553 Improved method for regeneration of absorbent.

US20120063980, High CO₂ to amine absorption capacity CO₂ scrubbing processes (Kortunov).

US20120279393 Removal of CO₂ from gases by means of aqueous amine solutions under the addition of a sterically hindered amine.

US20140178278 CO₂ capture via amine-CO₂ product phase separation.

US20140178279 An amine absorbent and a method for CO₂ capture.

U.S. Pat. No. 7,485,274 Apparatus and method for CO₂ recovery

U.S. Pat. No. 7,892,509 System and method for recovering CO₂.

U.S. Pat. No. 7,918,926, U.S. Pat. No. 8,409,339, U.S. Pat. No. 8,529,678, U.S. Pat. No. 8,535,427, U.S. Pat. No. 8,764,884, US20070283813, US20110113965, US20110113966, US20110120315, US20130323147, Apparatus and method for CO₂ recovery.

U.S. Pat. No. 8,105,420, Method for inhibiting amine degradation during CO₂ capture from a gas stream.

WO2012021728 Regeneration of amine solvents by geothermal heat for carbon dioxide capture and thermal compression.

WO2012034921 A process for the separation and capture of CO₂ from gas mixtures using amines solutions in anhydrous alcohols.

WO2012034921 A process for the separation and capture of CO₂ from gas mixtures using amines solutions in anhydrous alcohols.

Yang, J., et al., CO₂ Capture Using Amine Solution Mixed with Ionic Liquid. Industrial & Engineering Chemistry Research, 2014. 53(7): p. 2790-2799.

Rohm and Haas, AMBERLYST 15DRY Industrial Grade Strongly Acidic Catalyst, 2006

Zhao, M., Minett, A. I., and Harris, A. T., A review of techno-economic models for the retrofitting of conventional pulverised-coal power plants for post-combustion capture (PCC) of CO₂. Energy & Environmental Science, 2013. 6(1): p. 25-40.

1. An improved method of CO₂ capture, wherein CO₂ is absorbed by an aqueous solution of amines at a first temperature (T1) to form at least one amine-CO₂ reaction product, followed by desorption to regenerate said amines at a second temperature (T2) that is higher than T1, the improvement comprising adding a catalyst to said amine-CO₂ reaction product in an amount such that said desorption to regenerate said amine product occurs at a lower temperature than T2.

2. The method of claim 1, wherein said catalyst is chosen from vanadium oxide (V₂O₅), molybdenum trioxide (MoO₃), tungsten oxide (WO₃), iron oxide (Fe₂O₃), aluminum oxide (γ-Al₂O₃), zeolites, proton-exchange resins, or combinations thereof.

3. The method of claim 2, wherein said catalyst is a metal oxide chosen from vanadium oxide (V₂O₅), molybdenum trioxide (MoO₃), tungsten oxide (WO₃), aluminum oxide (γ-Al₂O₃), a zeolite or combinations thereof.

4. The method of claim 1, wherein said aqueous solution of amines is monoethanolamine (MEA).

5. The method of claim 1, wherein said aqueous solution of amines is two or more amine compounds, where at least one of the amines is a tertiary amine, and where at least one of the amines is a primary and/or a secondary amine, wherein the tertiary amine is DEEA and the primary and/or secondary amine(s) is selected from DAB, DAP, DiAP, DMPDA, HEP, or the tertiary amine is DIPAE, or N-TBDEA and primary and/or secondary amine(s) is selected from DAB, DAP, DiAP, DMPDA, HEP, MAPA, and MEA.

6. The method of claim 1, wherein said aqueous solution of amines is monoethanolamine (MEA) and said catalyst is vanadium oxide (V₂O₅).

7. A method of CO₂ capture, comprising:
a) passing CO₂ through a source of amine;
b) allowing said CO₂ to absorb into said amine to produce an amine-CO₂ reaction product; and
c) adding a metal oxide to said amine-CO₂ reaction product to regenerate said amine at a temperature lower than would be required without said metal oxide.

8. The method of claim 7, wherein said amine is bound to a solid support.

9. The method of claim 7, wherein said amine is in aqueous solution.

10. The method of claim 7, wherein said amine is in solution comprising a solvent.

11. The method of claim 7, wherein said metal oxide is V₂O₅.

12. The method of claim 7, wherein said metal oxide is molybdenum trioxide (MoO₃).

13. The method of claim 7, wherein said metal oxide is tungsten oxide (WO₃).

14. The method of claim 7, where said lower temperature is <100° C.

15. The method of claim 7, where metal oxide is V₂O₅ and said lower temperature is <90° C.

16. The method of claim 7, wherein said amine is MEA, said metal oxide is V₂O₅ and said lower temperature is <86° C.

17. The method of claim 7, wherein said amine comprises MEA.

18. The method of claim 7, wherein the amine is selected from the group consisting of, diethanolamine (DEA), diisopropanolamine (DIPA), and 2-hydroxyethyl piperazine (HEP).

19. The method of claim 7, wherein said amine is a mixture of a tertiary amine and a primary or secondary amine.

20. The method of claim 7, further comprising precipitating at least a portion of the amine-CO₂ reaction products.

21. The method of claim 9, wherein the aqueous solution comprises an additional absorption compound selected from the group consisting of piperidine, piperazine and derivatives thereof which are substituted by at least one alkanol group, alkanolamines, monoethanolamine (MEA), 2-amino-2-methyl-1-propanol (AMP), 2-(2-aminoethylamino)ethanol (AEE), 2-amino-2-hydroxymethyl-1,3-propanediol(Tris), amino acids, amino acids, taurine, N,cyclohexyl 1,3-propanediamine, N-secondary butyl glycine, N-methyl N-secondary butyl glycine, diethylglycine, dimethylglycine, sarcosine, methyl taurine, methyl-α-aminopropionic acid, N-(β-ethoxy)taurine, N-(β-aminoethy)taurine, N-methyl alanine, 6-aminohexanoic acid, or a combination thereof.

22. The method of claim 21, wherein the amino acid compound comprises at least one of the following: glycine, proline, arginine, histidine, lysine, aspartic acid, glutamic acid, methionine, serine, threonine, glutamine, cysteine, asparagine, valine, leucine, isoleucine, alanine, valine, tyrosine, tryptophan, phenylalanine; taurine, N,cyclohexyl 1,3-propanediamine, N-secondary butyl glycine, N-methyl N-secondary butyl glycine, diethylglycine, dimethylglycine, sarcosine, methyl taurine, methyl-α-aminopropionic acid, N-(β-ethoxy)taurine, N-(β-aminoethyl)taurine, N-methyl alanine, 6-aminohexanoic acid; or alkali salts thereof; or a combination thereof.

23. A method of CO₂ capture, comprising:
a) passing CO₂ through a source of amine on a solid support; and
b) allowing said CO₂ to absorb into said amine to produce an amine-CO₂ reaction product on said solid support; and
c) adding metal oxide selected from V₂O₅, MoO₃, WO₃, or combinations thereof to said amine-CO₂ reaction product on said solid support to regenerate said amine on said solid support at a temperature lower than would be required without said metal oxide.

24. An improved method of CO₂ capture, wherein CO₂ is absorbed by an aqueous solution of amines at 20-40° C. to form at least one amine-CO₂ reaction product, followed by desorption to regenerate said amines at 100-150° C., the improvement comprising adding a catalyst to said amine-CO₂ reaction product in an amount such that said desorption to regenerate said amine product occurs at a lower temperature.

25. The method of claim 24, wherein said lower temperature is below 100° C.

26. The method of claim 24, wherein said lower temperature is between 40-90° C.

27. The method of claim 24, wherein said lower temperature is between 50-84° C.

28. The method of claim 24, wherein said lower temperature is between 65-75° C.

29. The method of claim 24, wherein said chosen from vanadium oxide (V₂O₅), molybdenum trioxide (MoO₃), tungsten oxide (WO₃), iron oxide (Fe₂O₃), aluminum oxide (γ-Al₂O₃), zeolite, proton-exchange resin, or combinations thereof.

30. The method of claim 24, wherein said aqueous solution of amines is monoethanolamine (MEA).
